(19) United States
(12) Patent Application Publication
(10) Pub. No.: US 2022/0376242 A1
(43) Pub. Date: Nov. 24, 2022

(54) COMPOSITION FOR PREPARATION OF ELECTRODE MATERIAL

(71) Applicant: JOHNSON MATTHEY PUBLIC LIMITED COMPANY, London (GB)

(72) Inventors: Ian EDWORTHY, Billingham, Cleveland (GB); Katy LOVATT, Billingham, Cleveland (GB); Miquel PLANELLS, Billingham, Cleveland (GB); Maxwell SHAUGHNESSY, Billingham, Cleveland (GB)

(21) Appl. No.: 17/754,635

(22) PCT Filed: Oct. 16, 2020
(86) PCT No.: PCT/GB2020/052612

§ 371 Date: Apr. 7, 2022

(30) Foreign Application Priority Data
Oct. 18, 2019 (GB) 1915117.4

(51) Int. Cl. H01M 4/525; C01G 53/00; H01M 4/62; H01M 10/0525

(52) U.S. Cl. CPC H01M 4/525; C01G 53/66; H01M 4/625; H01M 4/623; H01M 10/0525; C01P 2006/40; C01P 2002/50; C01P 2002/60; C01P 2004/03

(57) ABSTRACT

A nickel-based hydroxide powder is provided which has an average crystallite size, as determined by Scherrer fitting of the (00I) reflections of an XRD powder diffraction pattern of the nickel-based hydroxide powder, of at most 10 nm, together with a process for producing nickel-based hydroxide powders. The nickel-based hydroxide powders find utility as precursors for the formation of lithium transition metal oxide active electrode materials.

### Field of the Invention

The present invention relates to a composition suitable for preparing an electrode material, particularly, although not exclusively, to compositions suitable for use in preparing a cathode material for lithium-ion rechargeable batteries, and a process for making such compositions.

### Background

Lithium-based batteries are used in a wide variety of applications, including, for example, portable electronic devices, electric tools, medical equipment, military, electric vehicle and aerospace applications. They generally have relatively high energy density, low self-discharge, and little memory effect.

A wide variety of materials are known for use in lithium-ion batteries. For example, handheld electronics commonly use lithium cobalt oxide materials (LiCₒO₂) as the active component of lithium battery cathodes. However, LiCₒO₂ lithium battery cathodes typically are expensive and exhibit relatively low capacity.

Other materials are known as alternatives to LiCoO₂ materials. For example, lithium iron phosphate (LiFePO4), lithium manganese oxide (LiMn₂O₄, Li₂MnO₃—“LMO”), lithium nickel oxide (LiNiO₂), lithium nickel cobalt aluminium oxide (LiNiCoAlO₂—“NCA”) and lithium nickel manganese cobalt oxide (LiNiMnCoO₂—“NMC”) materials are also known.

Nickel-based active electrode materials are generally less expensive than e.g. LiCoO₂ materials, and often exhibit higher specific capacity. However, nickel-based materials present some challenges in regards to safety and stability.

Commonly, such active electrode materials are formed by lithiating and oxidising a precursor material, which may be e.g. a transition metal hydroxide.

It is known that the properties (including electrochemical performance) of active electrode materials may be affected by the composition and morphology of a precursor material from which it is made. For example, EP3012227 A1 describes nickel-cobalt-manganese composite hydroxides which are precursor materials for a positive electrode active material of a non-aqueous electrolyte secondary battery, and aims to provide improved battery characteristics for a positive electrode active material made from these nickel-cobalt-manganese composite hydroxides.

In particular, the composition and morphology of the active electrode material can have a significant effect on factors relating to battery performance such as energy density, operating temperature, safety, durability, charging time, output power, cycle stability and cost of the resulting lithium-ion battery made using the active electrode material.

The present invention has been devised in light of the above considerations.

### SUMMARY OF THE INVENTION

The present inventors have realised that by controlling the composition and morphology of the precursor material(s) used in production of an active electrode material, the performance of an electrode comprising said active electrode material can be advantageously affected.

Accordingly, in a first aspect, the present invention provides a nickel-based hydroxide powder expressed by the general formula [NiₓCo_{y}A_{z}][Oₚ(OH)_{q}]ₐ, wherein:
A is one or more of V, Ti, B, Zr, Cu, Sn, Cr, Fe, Ga, Si, Mn, Mg, Sr, and Ca;
x satisfying 0.75≤x≤0.99
y satisfying 0≤y≤0.2
z satisfying 0<z≤0.1
wherein p is in the range 0≤p<1; q is in the range 0<q≤2; x+y+z=1 and a is selected such that the overall charge balance is 0; and
wherein the nickel-based hydroxide powder has an average crystallite size, as determined by Scherrer fitting of the (00l) reflections of an XRD powder diffraction pattern of the nickel-based hydroxide powder, of at most 10 nm.

Advantageously, the present inventors have realised that by providing a nickel-based hydroxide powder (precursor material) with an average crystallite size, as determined by Scherrer fitting of the (00l) reflections of an XRD powder diffraction pattern of the nickel-based hydroxide powder, of at most 10 nm, it is possible to provide electrodes comprising active electrode materials made from said precursor materials having improved performance, for example first cycle efficiency (FCE), in comparison to similar electrodes produced using precursor materials having an average crystallite size larger than 10 nm. Such electrodes may have an FCE of greater than or equal to 90%.

The crystallite size is determined for the nickel-based hydroxide powder (precursor material), rather than for the active electrode material itself, because the composition and morphology of the precursor material has a direct effect on the electrochemical performance of an active electrode material made from said precursor. Furthermore, precursor materials known in the art are typically commercially-sourced materials, used by battery manufacturers to form the active electrode material.

The average crystallite size of the nickel-based hydroxide powder (precursor material) is calculated from the powder XRD pattern. The (hkl) for each reflection associated with nickel hydroxide like phases are assigned with reference to a structure from a database (for example, the PDF-4+ database). The crystallite size is then calculated using Scherrer fitting of the (00l) reflections.

The Scherrer equation can be written as:

$$τ = \frac{K λ}{β cos θ}$$

where:
T (tau) is the mean size of the ordered (crystalline) domains (crystallite);
K is a dimensionless shape factor, with a value close to unity, and typically about 0.9;
A is the X-ray wavelength;
β is the line broadening at half the maximum intensity (FWHM), minus the instrumental line broadening, in radians;
θ is the Bragg angle.

The inventors have realised that there is a negative correlation between FCE% of an electrode and crystallite size of a precursor material used to produce said electrode. Preferably, the nickel-based hydroxide powder has an average crystallite size, as determined by Scherrer fitting of the (00l) reflections of an XRD powder diffraction pattern of the nickel-based hydroxide powder, of at most 9 nm, of at most 8 nm, at most 7 nm, at most 6 nm or at most 5 nm. Providing a lower average crystallite size can result in electrodes made using said precursor material having improved FCE%.

Preferably, the nickel-based hydroxide powder has an average crystallite size, as determined by Scherrer fitting of the (00l) reflections of an XRD powder diffraction pattern of the nickel-based hydroxide powder, of at least 2 nm. In other words, the average crystallite size is preferably in the range of 2 nm to 10 nm. In some cases, the nickel-based hydroxide powder may have an average crystallite size, as determined by Scherrer fitting of the (00l) reflections of an XRD powder diffraction pattern of the nickel-based hydroxide powder, of at least 3 nm, at least 4 nm or at least 5 nm.

The precursor materials are typically approximately spherical agglomerates of primary particles, each primary particle made up from one or more crystallites: these agglomerates are generally referred to as ‘secondary particles’.

As discussed above, the nickel-based hydroxide powder has a composition expressed by the general formula [NiₓCo_{y}A_{z}][Oₚ(OH)_{q}]ₐ. Preferred ranges for x, y, z, p, q and a are discussed below.

Preferably, x satisfies 0.8≤x≤0.99. By providing a relatively high nickel content, electrode materials produced from said precursor material may have a higher specific capacity than electrode materials produced from precursor materials having a lower nickel content. However, a very high nickel content may lead to challenges in respect of safety and stability of the electrode material. More preferably, x may therefore satisfy 0.85≤x≤0.97, even more preferably 0.9≤x≤0.95.

Preferably, at least one of y or z is greater than zero. In other words, preferably the nickel-based hydroxide powder includes at least one metal or metalloid element other than nickel. Both y and z may be greater than zero. In other words, the nickel-based hydroxide powder may include at least two metal or metalloid elements other than nickel.

Preferably, p is 0, and q is 2. In other words, preferably the nickel-based hydroxide powder is a pure metal hydroxide having the general formula [NiₓCo_{y}A_{z}][(OH)₂]ₐ. However, without wishing to be bound by theory, it is understood that some such materials may spontaneously partially oxidise in air to form an oxyhydroxide having the general formula [NiₓCo_{y}A_{z}][Oₚ(OH)_{q}]ₐ, where p>0. Where the nickel-based hydroxide powder has partially or completely oxidised, p may be greater than 0, and q may be less than 2.

As discussed above, a is selected such that the overall charge balance is 0. a may therefore satisfy 0.5≤a1.5. For example, a may be 1. Where A includes one or more metals not having a +2 valence state, or not present in a +2 valence state, a may be other than 1.

A is one or more of V, Ti, B, Zr, Cu, Sn, Cr, Fe, Ga, Si, Mn, Mg, Sr, and Ca, or may be one or more of V, Ti, B, Zr, Cu, Sn, Cr, Fe, Ga, Si, Mg, Sr, and Ca. Preferably A includes Mg, alone or in combination with one or more of said elements. Where A comprises more than one element, z is the sum amount of each of the elements making up A.

In some cases, for example where sulphate-based starting materials are used, the nickel-based hydroxide powder may contain sulphur anions, generally in the form of sulphate anions. The sulphur content of the nickel-based hydroxide powder may be less than 10000 ppm, less than 5000 ppm, less than 3000 ppm, or less than 1500 ppm. The sulphate content of the nickel-based hydroxide powder may be less than 30000 ppm, less than 15000 ppm or less than 9000 ppm. The sulphur content of the nickel-based hydroxide powder is preferably less than about 3000 ppm (about 9000 ppm or less of sulphate).

Advantageously, the present inventors have realised that by careful control of reaction conditions and the molar ratio of metal salt solution and ammonia solution used during precipitation, advantageous precursor materials may be produced, in particular those of the first aspect.

Therefore, in a second aspect, the present invention provides a method of making a nickel-based hydroxide powder expressed by the general formula [NiₓCo_{y}A_{z}][Oₚ(OH)_{q}]ₐa, wherein:
A is one or more of Al, V, Ti, B, Zr, Cu, Sn, Cr, Fe, Ga, Si, Zn, Mg, Mn, Sr, and Ca;
x satisfying 0.75≤x≤0.99
y satisfying 0≤y≤0.2
z satisfying 0≤z≤0.1
wherein p is in the range 0≤p<1; q is in the range 0<q≤2; x+y+z=1; and a is selected such that the overall charge balance is 0; the method including the steps of:
supplying, to a reaction vessel, a metal salt solution, a base solution, and an ammonia solution to thereby form an aqueous mixture within the reaction vessel, the metal:ammonia molar ratio of the metal salt solution and the ammonia solution supplied to the reaction vessel being in a range from 1:1 to 1:2.25;
mixing the aqueous mixture in the reaction vessel at a reaction temperature of 30-80° C.;
adjusting the flow rate or addition amount of the base solution to control the pH of the aqueous mixture to be in the range of 9 to 13, to cause precipitation of the nickel-based hydroxide from the aqueous mixture;
filtering the solution to extract the precipitated nickel-based hydroxide; and
drying to obtain the nickel-based hydroxide powder.

The method of making a nickel-based hydroxide powder may be a batch method. The reaction vessel may be an open reaction vessel. Alternatively, the reaction vessel may be a closed or sealed reaction vessel. Where the reaction vessel is an open reaction vessel this may allow for some evaporation of reagents from the reaction vessel. Use of a closed or sealed reaction vessel may limit or prevent evaporation of reagents from the reaction vessel, which may, in some cases, result in larger crystallite size. Accordingly, in some methods, the reaction vessel is not a sealed vessel.

The reaction temperature may be 75° C. or less, 70° C. or less or 65° C. or less. The reaction temperature may be 30° C. or more, 40° C. or more 50° C. or more or 55° C. or more. Preferably, the reaction temperature is in a range of 50° C. to 70° C., more preferably in a range of 55° C. to 65° C. It is considered that providing a reaction temperature in these ranges may result in production of a nickel-based hydroxide powder having an appropriate crystallite size.

Preferably the metal salt solution is a metal sulphate solution. The metal salt solution may be a mixed metal salt solution. For example, the metal salt solution may comprise a mixed metal sulphate solution comprising two or more different metal sulphates. Non-limiting examples of suitable metal sulphates include nickel sulphate hexahydrate, cobalt sulfate heptahydrate and magnesium sulphate. The present inventors have found that use of a metal salt solution comprising metal sulphates may lead to improved performance of resultant active electrode materials produced from nickel-based hydroxide powders according to the invention.

However, there are a wide number of other suitable metal salts which may be suitable for use in the present invention. For example, the metal salt solution may be e.g. a metal nitrate solution.

The total metal concentration in the metal salt solution may be between about 0.5 M and about 2.0 M, more preferably between about 1.0 M and about 1.5 M. In preferred arrangements the total metal concentration may be about 1.3 M.

The metal: ammonia molar ratio of the metal salt solution and the ammonia solution supplied to the reaction vessel is in a range from 1:1 up to 1:2.25. More preferably, the metal:ammonia ratio in the reaction vessel is between about 1:1.75 and 1:2. It is considered that providing a total metal: ammonia ratio in these ranges may result in production of a nickel-based hydroxide powder having an appropriate crystallite size. Methods in which the metal:ammonia molar ratio of the metal salt solution and the ammonia solution supplied to the reaction vessel is greater than 1:2.25 (for example, in a ratio of up to 1:8) may produce a nickel-based hydroxide powder as defined in relation to the first aspect, other than that the average crystallite size, as determined by Scherrer fitting of the (00l) reflections of an XRD powder diffraction pattern of the nickel-based hydroxide powder, may be greater than 10 nm.

The base solution may be, e.g. NaOH. Although a number of different bases may be suitable. For example, suitable base solutions may include LiOH, KOH, Na₂CO₃, NaHCO3, K2CO3, KHCO3. The concentration of the base solution may be selected as appropriate for the particular base solution being used. The base solution may be used at a concentration of e.g. from 0.5 M to 10 M. A particular preferred base solution and concentration is 2M NaOH.

The pH of the aqueous mixture may be controlled to be at least 10, preferably at least 10.6. The pH of the aqueous mixture may be controlled to be at most 12, preferably at most 11.2. Preferably the pH of the aqueous mixture is controlled to be in a range of 10.6 to 11.2. Whilst precipitation of the nickel-based hydroxide powder may occur at pHs above about pH 7, it is considered that providing a pH in the ranges specified above may result in a nickel-based hydroxide powder having an appropriate crystallite size.

The reaction time may be between 6 and 30 hours. For example, the reaction time may be 6 hours or more, 10 hours or more, 15 hours or more or 24 hours or more. The reaction time may be 30 hours or less, 24 hours or less, 15 hours or less or 10 hours or less.

In a third aspect, the present invention provides an active electrode material produced by a method comprising the step of dry-mixing a nickel-based hydroxide powder of the first aspect, or a nickel-based hydroxide powder produced by the process of the second aspect, with a lithium salt, followed by calcining in an oxidising atmosphere. The lithium salt may be, e.g. lithium hydroxide. The active electrode material may be a lithium transition metal oxide.

In a fourth aspect, the present invention provides a method of making an active electrode material, including the steps of dry-mixing a nickel-based hydroxide powder of the first aspect, or a nickel-based hydroxide powder produced by the process of the second aspect, with a lithium salt, followed by calcining in an oxidising atmosphere. The lithium salt may be, e.g. lithium hydroxide. The active electrode material may be a lithium transition metal oxide.

The nickel-based hydroxide powder may be mixed with the lithium salt in an appropriate ratio to obtain a lithium transition metal oxide with Li to metal ratio of between 0.9 and 1.3. Preferably, the nickel-based hydroxide powder may be mixed with the lithium salt in an appropriate ratio to obtain a lithium transition metal oxide with Li to metal ratio of between 0.95 and 1.1.

Calcining may take place in a temperature range of 500-1000° C., preferably in a range of 600-800° C., more preferably about 700° C. Calcining may be performed for a time of 2-24 hours, preferably 3-10 hours, more preferably about 6 hours.

The oxidising atmosphere may be, for example, dry CO₂-free air, although any suitable atmosphere may be used.

In a fifth aspect, the present invention provides an electrode comprising a material according to the third aspect of the invention, a conductive additive, and a binder.

A wide range of suitable conductive additives and binders are known in the art. Preferably, the conductive additive is a carbonaceous material. The conductive additive may be carbon. One example of a conductive additive that is particularly suitable is Super C-65, purchased from Imerys; also known as Timical Super C65.

The binder may be one or more suitable materials including, for example, polyvinylidene fluoride (PVDF), polytetrafluoroethylene (PTFE), and Styrene-Butadiene Rubber/Carboxymethylcellulose (SBR/CMC). Polyvinylidene fluoride (PVDF) is a binder that is particularly suitable for use with the above materials.

Where appropriate, the binder may first be dissolved in an appropriate solvent, for example N-methyl-2-pyrrolidine (NMP).

In a sixth aspect, the present invention provides an electrochemical cell comprising an electrode according to the fifth aspect of the invention.

In a seventh aspect, the present invention provides the use of a nickel-based hydroxide powder satisfying requirements (1) and (2) as a precursor in the preparation of a lithium transition metal oxide active electrode material:
(1) the nickel-based hydroxide powder is expressed by the general formula [NiₓCo_{y}A_{z}][Oₚ(OH)_{q}]ₐ, wherein:
A is one or more of Al, V, Ti, B, Zr, Cu, Sn, Cr, Fe, Ga, Si, Zn, Mg, Mn, Sr, and Ca;
x satisfying 0.75≤x≤0.99
y satisfying 0≤y≤0.2
z satisfying 0≤z≤0.1

wherein p is in the range 0≤p<1; q is in the range 0<q≤2; x+y+z=1; and a is selected such that the overall charge balance is 0; and
(2) the nickel-based hydroxide powder has an average crystallite size, as determined by Scherrer fitting of the (00l) reflections of an XRD powder diffraction pattern of the nickel-based hydroxide powder, of at most 10 nm.

It may be preferred to use a nickel-based hydroxide powder according to the first aspect and in which z satisfies 0 <z 0.1 and A is one or more of V, Ti, B, Zr, Cu, Sn, Cr, Fe, Ga, Si, Mg, Mn, Sr, and Ca. It may be particularly preferred to use a nickel-based hydroxide powder in which in which z satisfies 0<z≤0.1 and A is Mg.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1. is a scatter plot showing crystallite size against first cycle efficiency % (FCE%) for a number of samples of nickel-based hydroxide powder.

FIG. 2. is an SEM image showing the general morphology of a precursor material produced by the method described herein.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

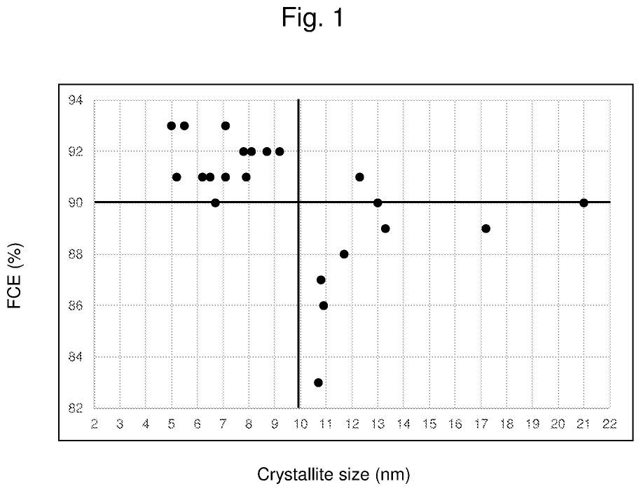

FIG. 1 is a scatter plot showing crystallite size against first cycle efficiency % (FCE%) for a number of samples of nickel-based hydroxide powder. As shown in FIG. 1, by providing a nickel-based hydroxide powder (precursor material) with an average crystallite size, as determined by Scherrer fitting of the (00l) reflections of an XRD powder diffraction pattern of the nickel-based hydroxide powder, of at most 10 nm, it may be possible to provide electrode materials made from said precursor material having improved first cycle efficiency (FCE) in comparison to similar electrode materials produced from precursor materials having an average crystallite size or larger than 10 nm.

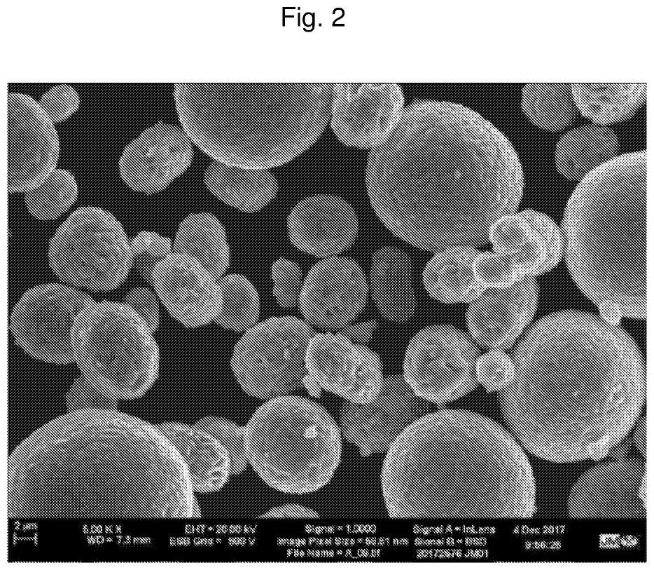

As discussed above, one or more crystallites form primary particles. These primary particles typically agglomerate into substantially spherical secondary particles, as seen in FIG. 2, which is an SEM image showing the general morphology of a precursor material formed by the process as described herein. Secondary particles having a diameter in the range of approximately 2-10 μm can be seen.

As discussed above, the precursor materials described herein can be used to form active electrode materials e.g. lithium transition metal oxide materials, by lithiation and oxidation. The electrochemical performance (primarily first cycle efficiency FCE%) of electrodes formed from such materials has been assessed in a manner described in further detail below.

Each of the samples discussed below is a precursor of the composition Ni_{0.91}Co_{0.08}Mg_{0.01}(OH)₂. However, each sample is prepared using different precipitation conditions. The crystallite size data reported is of the precursor material. This is then lithiated and oxidised to form an active electrode material having a composition Li_{1.03}Ni_{0.91}Co_{0.08}Mg_{0.01}O₂, from which an electrode is formed and electrochemically characterised.

### CONDITIONS FOR PRECURSOR PRECIPITATION

### Precursor Precipitation Operation

Detailed example sample A: A mixed metal sulphate solution (1.33 M) comprising nickel sulphate hexahydrate, cobalt sulfate heptahydrate and magnesium sulphate at a metal molar ratio of 0.91:0.08:0.01, base solution (2M NaOH) and ammonia solution (2M) were heated to 45° C. then co-fed to a baffled reactor fitted with an agitator set at 450 rpm. The reactor begins with a 1 L heel of water with 50 mL ammonia and a few drops of NaOH to start with a pH of 11 at 45° C. The solutions were pumped to the vessel, using peristaltic pumps over a period of 5 hours with the reaction temperature maintained at 45° C. The pH for the precipitation in this example was 11. The vessel was an open vessel (no lid). The mixed metal flow rate was kept constant at about 3 mL/min, the ammonia solution was fed in at a fixed rate in a 1:1 molar ratio with the metals solution and the pH of the solution adjusted by varying the flow rate of the base solution. The slurry was then vacuum filtered. The obtained solid was washed with hot (about 40° C.) deionised water to remove sodium and sulphate ions. The washed filter cake was then tray dried at 120° C. overnight.

Samples B, C, D and E were obtained as for sample A with the modification that the reaction time was within the range of 5 to 31 hours.
Sample B
   Reaction time: 19 h
Sample C (repeat of B)
   Reaction time: 19 h
Sample D
   Reaction time: 26 h
Sample E
   Reaction time: 31 h

Samples F and G were obtained as for sample A with the modification that the flow rate of the base solution was fixed at 1 mL/min, the temperature was fixed at 60° C. and the reaction time was varied within the range of 18 to 24 hours.
Sample F
   Reaction time: 18 h
Sample G
   Reaction time: 24 h

Samples H, I, J, K, L were obtained as for sample A with the modification that the flow rate of the base solution was fixed at 1 mL/min, the reaction time was fixed at 24 hours and the ammonia-to-metal molar ratio was varied within the range of 1:1 to 8:1.
Sample H
   Ammonia-to-metal molar ratio: 2:1 ratio
Sample I
   Ammonia-to-metal molar ratio: 4:1 ratio
Sample J
   Ammonia-to-metal molar ratio: 6:1 ratio
Sample K (repeat of J with Rushton turbine impeller added to agitation)
   Ammonia-to-metal molar ratio: 6:1 ratio
Sample L
   Ammonia-to-metal molar ratio: 8:1 ratio

Sample M and N were obtained as for sample A with the modification that the flow rate of the base solution was fixed at 1 mL/min, the ammonia-to-metal molar ratio was fixed at 2.4:1 and the temperature was varied within the range of 45 to 60° C., and wherein the reaction was carried out in a closed vessel, thereby reducing evaporation of e.g. ammonia.
Sample M
   Temperature: 45° C.
Sample N
   Temperature: 60° C.

Sample O was obtained as for sample A with the modification that the flow rate of the base solution was fixed at 1 mL/min, the NaOH concentration was changed to 8.33 M, the ammonia-to-metal ratio was changed to 2:1, the reaction time was 24 hours, the pH was used was 10.6, temperature was 60° C. and stirring speed was 800 rpm.

Sample P was obtained as for sample A with the modification that the flow rate of the base solution was fixed at 1 mL/min, the NaOH concentration was changed to 8.33 M, the ammonia-to-metal ratio was changed to 2.4:1, the reaction time was 24 hours, the pH was used was 10.6, temperature was 60° C. and stirring speed was 800 rpm.

Sample Q was obtained as for sample A with the modification that the flow rate of the base solution was fixed at 1 mL/min, the NaOH concentration was changed to 8.33 M, the ammonia-to-metal ratio was changed to 2:1, the reaction time was 8 hours, the pH was used was 10.6, temperature was 60° C. and stirring speed was 800 rpm.

Sample R was obtained as for sample A with the modification that the flow rate of the base solution was fixed at 1.34 mL/min, the NaOH concentration was changed to 8.33 M, the ammonia-to-metal ratio was changed to 1.5:1, the reaction time was 24 hours, the pH was used was 10.6, temperature was 50° C. and stirring speed was 800 rpm.

Sample S was obtained as for sample A with the modification that the flow rate of the base solution was fixed at 0.93 mL/min, mixed metal sulphate solution concentrated was changed to 1.9 M, the NaOH concentration was changed to 8.33 M, the ammonia-to-metal ratio was changed to 3:1, the reaction time was 24 hours, the pH was used was 10.6, temperature was 50° C. and stirring speed was 650 rpm.

Sample T was obtained as for sample A with the modification that the flow rate of the base solution was fixed at 1 mL/min, the NaOH concentration was changed to 8.33 M, the ammonia-to-metal ratio was changed to 2:1, the reaction time was 24 hours.

Sample U was obtained as for sample A with the modification that the flow rate of the base solution was fixed at 1 mL/min, the NaOH concentration was changed to 8.33 M, the ammonia-to-metal ratio was changed to 1.75:1, the reaction time was 24 hours, the pH was used was 10.6, temperature was 60° C. and stirring speed was 800 rpm. The reaction was performed in a sealed vessel with a positive pressure of N₂.

Sample V was obtained as for sample A with the modification that the flow rate of the base solution was fixed at 1 mL/min, the NaOH concentration was changed to 8.33 M, the ammonia-to-metal ratio was changed to 2:1, the reaction time was 24 hours, the pH was used was 10.6, temperature was 60° C. and stirring speed was 800 rpm. The reaction was performed in a sealed vessel with a positive pressure of N₂.

Conditions for lithiation & oxidation of precursor

A blend of 25 grams total of precursor and dry LiOH with a molar ratio (Li:M) of 1.03 was mixed thoroughly and added onto an alumina crucible. The mixture was calcined in an oven under 2.4 L/min of CO₂ free air. The two-stage ramp 5° C./min up to 450° C., hold for 2 hours followed by 2° C./min up to 700° C., hold for 6 hours, were carried out.

Experimental protocol for XRD crystallite size measurement

Powder X-ray diffraction (PXRD) data were collected in reflection geometry using a Bruker AXS D8 diffractometer using Cu Ka radiation (λ=1.5406+1.54439 Å) over the 10<2θ<100° range in 0.02° steps. Phase identification was conducted using Bruker AXS Diffrac Eva V4.2 (2014) with reference to the PDF-4+ database, to ensure that all of the observed scattering could be assigned to nickel hydroxide like phases, and to identify (00l) reflections.

Peak fitting was performed using Topas^{[1]} over the 12<2θ<24° range using a Split Pearson VII convoluted with instrumental parameters. The instrumental parameters were determined using a fundamental parameters approach^{[2]} using reference data collected from NIST660 LaB_{6.} Crystallite sizes have been calculated using the volume weighted column height LVol-IB method.^{[3]}

Experimental protocol for electrochemical characterisation

The electrodes were prepared by blending 94%wt of active material, 3%wt of carbon grade Super C-65 (purchased from Imerys; also known as Timical Super C65) as conductive additive and 3%wt of polyvinylidene fluoride (PVDF) as binder in N-methyl-2-pyrrolidine (NMP) as solvent. The slurry was added onto a reservoir and a 125 μm doctor blade coating (Erichsen) was applied. The electrode was dried at 120° C. for 1 hour before being pressed to achieve a density of 3.0 g/cm³. Typically, the loading of active material is 9 mg/cm². The pressed electrode was cut into 14 mm disks and further dried at 120° C. under vacuum for 12 hours.

Electrochemical testing was performed with a CR2025-type coin cell, which was assembled in an argon filled glove box (MBraun). Lithium foil was used as an anode. A porous polypropylene membrane (Celgrad 2400) was used as a separator. 1M LiPF₆ in 1:1:1 mixture of ethylene carbonate (EC), dimethyl carbonate (DMC) and ethyl methyl carbonate (EMC) with 1% of vinyl carbonate (VC) was used as electrolyte.

The cells were tested on a MACCOR 4000 series and were charged and discharged at 0.1C (1C=200 mAh/g) between 3.0 and 4.3 V at 23° C. First cycle efficiency (FCE) is defined as the percentage ratio between the first charge and discharge capacities.

TABLE 1
precursor average crystallite size against measured FCE
% for electrodes made using said precursor sample.

| Sample # | CS_001 (nm) | FCE (%) |
|---|---|---|
| A | 7.1 | 93 |
| B | 6.5 | 91 |
| C | 6.7 | 90 |
| D | 6.2 | 91 |
| E | 5.2 | 91 |
| F | 5.0 | 93 |
| G | 5.5 | 93 |
| H | 8.1 | 92 |
| I | 7.1 | 91 |
| J | 13.3 | 89 |
| K | 12.3 | 91 |
| L | 11.7 | 88 |
| M | 10.9 | 86 |
| N | 10.8 | 87 |
| O | 7.8 | 92 |
| P | 9.2 | 92 |
| Q | 8.7 | 92 |
| R | 7.9 | 91 |
| S | 17.2 | 89 |
| T | 10.7 | 83 |
| U | 13.0 | 90 |
| V | 21.0 | 90 |

***

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/− 10%.

### REFERENCES

A number of publications are cited above in order to more fully describe and disclose the invention and the state of the art to which the invention pertains. Citations for these references are provided below. The entirety of each of these references is incorporated herein.
1. Topas v5.0: General Profile and Structure Analysis Software for Powder Diffraction Data, Bruker AXS, Karlsruhe, Germany, (2003-2015).
2. R.W. Cheary and A. Coelho, J. Appl. Cryst. (1992), 25, 109-121
3. F. Bertaut and P. Blum (1949) C.R. Acad. Sci. Paris 229, 666

1-25 (canceled)

26. A nickel-based hydroxide powder expressed by the general formula [NiₓCo_{y}A_{z}][Oₚ(OH)_{q}]ₐ, wherein:
A is one or more of V, Ti, B, Zr, Cu, Sn, Cr, Fe, Ga, Si, Mn, Mg, Sr, and Ca;
x satisfying 0.75≤x≤0.99
y satisfying 0≤y≤0.2
z satisfying 0<z≤0.1
wherein p is in the range 0≤p<1; q is in the range 0<q≤2; x+y+z=1; and a is selected such that the overall charge balance is 0; and
wherein the nickel-based hydroxide powder has an average crystallite size, as determined by Scherrer fitting of the (00l) reflections of an XRD powder diffraction pattern of the nickel-based hydroxide powder, of at most 10 nm.

27. The nickel-based hydroxide powder according to claim 26 wherein A is one or more of V, Ti, B, Zr, Cu, Sn, Cr, Fe, Ga, Si, Mg, Sr, and Ca.

28. The nickel-based hydroxide powder according to claim 26 wherein the nickel-based hydroxide powder has an average crystallite size, as determined by Scherrer fitting of the (00l) reflections of an XRD powder diffraction pattern of the nickel-based hydroxide powder, of at least 2 nm.

29. The nickel-based hydroxide powder according to claim 26 wherein the nickel-based hydroxide powder has an average crystallite size, as determined by Scherrer fitting of the (00l) reflections of an XRD powder diffraction pattern of the nickel-based hydroxide powder, of at most 9 nm, or of at most 8 nm.

30. The nickel-based hydroxide powder according to claim 26 wherein x satisfies 0.8≤x≤0.99.

31. The nickel-based hydroxide powder according to according to claim 26 wherein y greater than zero.

32. The nickel-based hydroxide powder according to claim 26 wherein p is 0, and q is 2.

33. The nickel-based hydroxide powder according to claim 26 wherein A includes Mg.

34. The nickel-based hydroxide powder according to claim 26 wherein A is Mg.

35. The nickel-based hydroxide powder according to claim 26 wherein the sulphur content is less than 10000 ppm.

36. An active electrode material produced by a method comprising the step of dry-mixing a nickel-based hydroxide powder according to claim 26 with a lithium salt, followed by calcining in an oxidising atmosphere.

37. An active electrode material according to claim 36 wherein the lithium salt is lithium hydroxide.

38. An active electrode material according to claim 36 wherein the active electrode material is a lithium transition metal oxide.

39. An electrode comprising an active electrode material according to claim 36, a conductive additive, and a binder.

40. An electrochemical cell comprising an electrode according to claim 39.

41. The use of a nickel-based hydroxide powder satisfying requirements (1) and (2) as a precursor in the preparation of a lithium transition metal oxide active electrode material:
(1) the nickel-based hydroxide powder is expressed by the general formula [NiₓCo_{y}A_{z}][Oₚ(OH)_{q}]ₐ, wherein:
A is one or more of V, Ti, B, Zr, Cu, Sn, Cr, Fe, Ga, Si, Mn, Mg, Sr, and Ca;
x satisfying 0.75≤x≤0.99
y satisfying 0≤y≤0.2
z satisfying 0<z≤0.1
wherein p is in the range 0≤p<1; q is in the range 0<q≤2; x+y+z=1; and a is selected such that the overall charge balance is 0; and
(2) the nickel-based hydroxide powder has an average crystallite size, as determined by Scherrer fitting of the (00l) reflections of an XRD powder diffraction pattern of the nickel-based hydroxide powder, of at most 10 nm.

42. The use according to claim 41 wherein the nickel-based hydroxide powder is expressed by the general formula [NiₓCo_{y}A_{z}][Oₚ(OH)_{q}]ₐ, wherein:
A is one or more of V, Ti, B, Zr, Cu, Sn, Cr, Fe, Ga, Si, Mn, Mg, Sr, and Ca;
x satisfying 0.75≤x≤0.99
y satisfying 0≤y≤0.2
z satisfying 0<z≤0.1
wherein p is in the range 0≤p<1; q is in the range 0<q≤2; x+y+z=1; and a is selected such that the overall charge balance is 0; and
wherein the nickel-based hydroxide powder has an average crystallite size, as determined by Scherrer fitting of the (00l) reflections of an XRD powder diffraction pattern of the nickel-based hydroxide powder, of at most 10 nm.

43. A method of making a nickel-based hydroxide powder expressed by the general formula [NiₓCo_{y}A_{z}][Oₚ(OH)_{q}]ₐ, wherein:
A is one or more of V, Ti, B, Zr, Cu, Sn, Cr, Fe, Ga, Si, Mn, Mg, Sr, and Ca;
x satisfying 0.75≤x≤0.99
y satisfying 0≤y≤0.2
z satisfying 0≤<z≤0.1
wherein p is in the range 0≤p<1; q is in the range 0<q≤2; x+y+z=1; and a is selected such that the overall charge balance is 0;
the method including the steps of:
supplying, to a reaction vessel, a metal salt solution, a base solution, and an ammonia solution to thereby form an aqueous mixture within the reaction vessel, the metal:ammonia molar ratio of the metal salt solution and the ammonia solution supplied to the reaction vessel being in a range from 1:1 to 1:2.25;
mixing the aqueous mixture in the reaction vessel at a reaction temperature of 30-80° C.;
adjusting the flow rate or addition amount of the base solution to control the pH of the aqueous mixture to be in the range of 9 to 13, to cause precipitation of the nickel-based hydroxide from the aqueous mixture;
filtering the aqueous mixture to extract the precipitated nickel-based hydroxide; and
drying to obtain the nickel-based hydroxide powder.

44. A method according to claim 43 wherein the nickel-based hydroxide powder has an average crystallite size, as determined by Scherrer fitting of the (00l) reflections of an XRD powder diffraction pattern of the nickel-based hydroxide powder, of at most 10 nm.

45. A method according to claim 43 wherein the nickel-based hydroxide powder is expressed by the general formula [NiₓCo_{y}A_{z}][Oₚ(OH)_{q}]ₐ, wherein:
A is one or more of V, Ti, B, Zr, Cu, Sn, Cr, Fe, Ga, Si, Mn, Mg, Sr, and Ca;
x satisfying 0.75≤x≤0.99
y satisfying 0≤y≤0.2
z satisfying 0<z≤0.1
wherein p is in the range 0≤p<1; q is in the range 0<q≤2; x+y+z=1; and a is selected such that the overall charge balance is 0; and
wherein the nickel-based hydroxide powder has an average crystallite size, as determined by Scherrer fitting of the (00l) reflections of an XRD powder diffraction pattern of the nickel-based hydroxide powder, of at most 10 nm.

46. A method according to claim 43 wherein the metal salt solution is a metal sulphate solution or a metal nitrate solution.

47. A method according to claim 46 wherein the metal salt solution is a mixed metal sulphate solution comprising two or more different metal sulphates.

48. A method according to claim 43 wherein the total metal:ammonia ratio is in a range from 1:1.75 to 1:2.

49. A method according to claim 43 wherein the pH of the aqueous mixture is controlled to be in the range of 10.6 to 11.2.

50. A method according to claim 43 wherein the reaction time is between 6 and 30 hours.
